(19) United States
(12) Patent Application Publication
(10) Pub. No.: US 2024/0163809 A1
(43) Pub. Date: May 16, 2024

(54) WAVEFORM SHAPING FOR A USER EQUIPMENT (UE)

(71) Applicant: QUALCOMM Incorporated, San Diego, CA (US)

(72) Inventors: Gokul Sridharan, Sunnyvale, CA (US); Peter Gaal, San Diego, CA (US)

(21) Appl. No.: 18/507,862

(22) Filed: Nov. 13, 2023

Related U.S. Application Data
(60) Provisional application No. 63/383,640, filed on Nov. 14, 2022.

(51) Int. Cl. H04W 52/32; H04W 52/36

(52) U.S. Cl. CPC H04W 52/325; H04W 52/365

(57) ABSTRACT

An apparatus for wireless communication by a user equipment (UE) includes a transmitter configured to transmit a UE capability message indicating one or more waveform shaping capabilities of the UE. The apparatus further includes a receiver configured to receive a configuration message indicating a waveform shaping configuration in accordance with the one or more waveform shaping capabilities. The transmitter is further configured to transmit a signal in accordance with the waveform shaping configuration. The signal has a transmit power level associated with the waveform shaping configuration.

### CROSS-REFERENCE TO RELATED APPLICATIONS

This application claims the benefit of U.S. Prov. Pat. App. No. 63/383,640, entitled “WAVEFORM SHAPING FOR A USER EQUIPMENT (UE)” and filed on Nov. 14, 2022, which is expressly incorporated by reference herein in its entirety.

### TECHNICAL FIELD

Aspects of the present disclosure relate generally to wireless communication systems, and more particularly, to waveform shaping for a user equipment (UE) of a wireless communication system.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for one or more user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

In some aspects of the disclosure, an apparatus for wireless communication by a user equipment (UE) includes a transmitter configured to transmit a UE capability message indicating one or more waveform shaping capabilities of the UE. The apparatus further includes a receiver configured to receive a configuration message indicating a waveform shaping configuration in accordance with the one or more waveform shaping capabilities. The transmitter is further configured to transmit a signal in accordance with the waveform shaping configuration. The signal has a transmit power level associated with the waveform shaping configuration.

In some other aspects of the disclosure, a method of wireless communication performed by a UE includes transmitting a UE capability message indicating one or more waveform shaping capabilities of the UE. The method further includes receiving a configuration message indicating a waveform shaping configuration in accordance with the one or more waveform shaping capabilities. The method further includes transmitting a signal in accordance with the waveform shaping configuration. The signal has a transmit power level associated with the waveform shaping configuration.

In some other aspects of the disclosure, an apparatus for wireless communication by a network node includes a receiver configured to receive a UE capability message indicating one or more waveform shaping capabilities of a UE. The apparatus further includes a transmitter configured to transmit a configuration message indicating a waveform shaping configuration in accordance with the one or more waveform shaping capabilities. The receiver is further configured to receive a signal in accordance with the waveform shaping configuration. The signal has a transmit power level associated with the waveform shaping configuration.

In some other aspects of the disclosure, a method of wireless communication performed by a network node includes receiving a UE capability message indicating one or more waveform shaping capabilities of a UE. The method further includes transmitting a configuration message indicating a waveform shaping configuration in accordance with the one or more waveform shaping capabilities. The method further includes receiving a signal in accordance with the waveform shaping configuration. The signal has a transmit power level associated with the waveform shaping configuration.

### BRIEF DESCRIPTION OF THE DRAWINGS

FIG. 1 is a block diagram illustrating example details of an example wireless communication system that supports waveform shaping according to one or more aspects of the disclosure.

FIG. 2 is a block diagram illustrating examples of a base station and a user equipment (UE) that support waveform shaping according to one or more aspects of the disclosure.

FIG. 3 is a block diagram illustrating an example of a wireless communication system 300 that supports waveform shaping according to one or more aspects of the disclosure.

FIG. 4 depicts examples of operations that may support waveform shaping according to one or more aspects of the disclosure.

FIG. 5 depicts an example of a frequency domain spectrum shaping (FDSS) operation that may support waveform shaping according to one or more aspects of the disclosure.

FIG. 6 is a flow diagram illustrating an example process that supports waveform shaping according to one or more aspects of the disclosure.

FIG. 7 is a flow diagram illustrating an example process that supports waveform shaping according to one or more aspects of the disclosure.

FIG. 8 is a block diagram of an example UE that supports waveform shaping according to one or more aspects of the disclosure.

FIG. 9 is a block diagram of an example base station that supports waveform shaping according to one or more aspects of the disclosure.

FIG. 10 is a block diagram illustrating an example disaggregated base station architecture that supports waveform shaping according to one or more aspects of the disclosure.

### DETAILED DESCRIPTION

A user equipment (UE) may transmit different signals to other devices, such as a base station. In some circumstances, a signal transmitted by the UE may have a waveform that is relatively “difficult” for the UE to generate. For example, a signal may have a relatively large degree dynamic range, which may result in distortion of the signal, such as by causing saturation during power amplification of the signal by the UE. Distortion and other effects in the signal may reduce ability of the base station (or other device) to receive the signal.

Some UEs may include certain circuitry to reduce such distortion and other effects. For example, a UE may include a transmitter having one or more power amplifiers or other circuits designed to reduce such distortion and other effects. To illustrate, a transmitter may include a predistortion circuit applies predistortion to a signal input to a power amplifier of the transmitter, which may compensate for power amplifier distortion in the signal. Such circuitry may be expensive and may increase device cost. Further, in some examples, such circuitry may utilize a relatively large amount of power and processing resources of a UE.

To reduce distortion or other effects without using such circuitry, some wireless communication protocols may specify maximum power reduction (MPR) values. A UE may use the MPR values to reduce a transmit power level of a signal that is “challenging” to generate. By using the MPR values, the UE may reduce distortion or other effects (such as by reducing power amplifier saturation). Use of the MPR values may reduce range and communication capability of the UE by reducing transmit power associated with the signals.

In some aspects of the disclosure, a UE may perform waveform shaping of a signal to reduce such distortion or other effects in the signal. The waveform shaping may include adding “excess” bandwidth, resources, tones, or resource blocks (RBs) to the signal. Performing the waveform shaping may include modifying the waveform of the signal so that the signal is “easier” to transmit, such as by reducing a peak-to-average power ratio (PAPR) of the signal. In some examples, the UE may indicate one or more waveform shaping capabilities to a base station, and the base station may configure the UE with a waveform shaping configuration based on the one or more waveform shaping capabilities. The UE may perform the waveform shaping in accordance with the waveform shaping configuration.

In some examples, the waveform shaping may include adding resource blocks (RBs), bandwidth, or tones to a signal to be transmitted, which may be referred to herein as “excess” bandwidth. Alternatively or in addition, the waveform shaping may include performing shaping of the signal, such as frequency domain spectrum shaping (FDSS). The FDSS may be performed with or without adding “excess” bandwidth to the signal.

By performing the waveform shaping, the UE may avoid or reduce an amount of MPR applied to a signal. As a result, a transmit power level of the signal may be increased, increasing range of the signal and communication capability of the UE as compared to other techniques, such as techniques that use MPR (or a “full” MPR). Further, the UE may avoid certain circuitry associated with reduction of distortion and other effects, which may reduce device cost, power consumption, and usage of processing resources.

One or more techniques described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RAT s) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

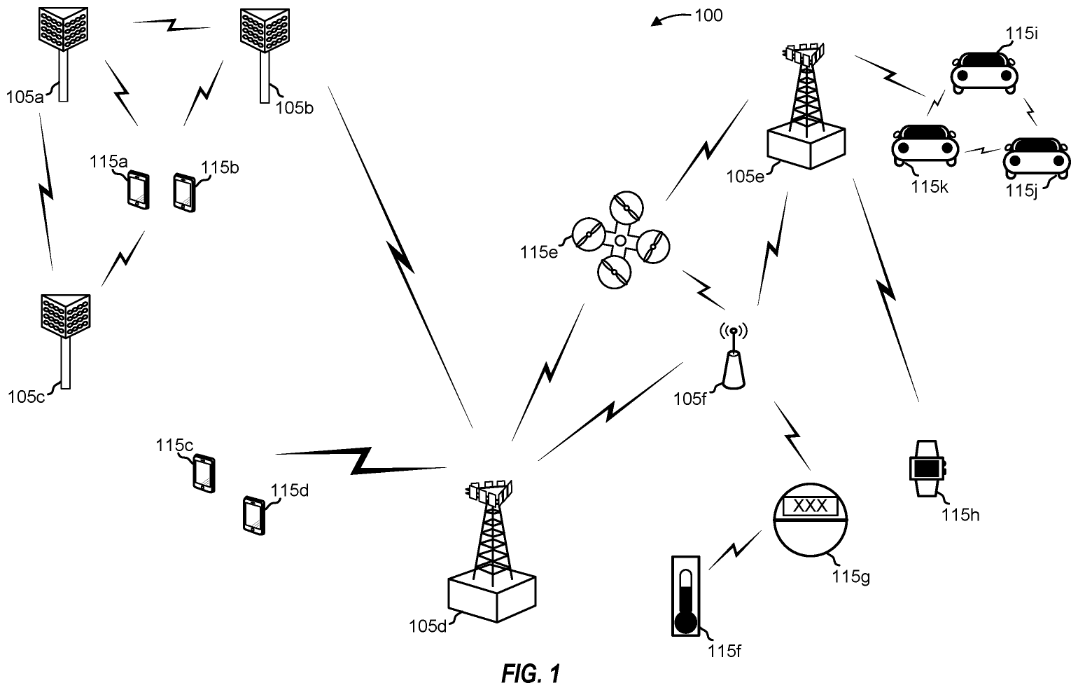

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

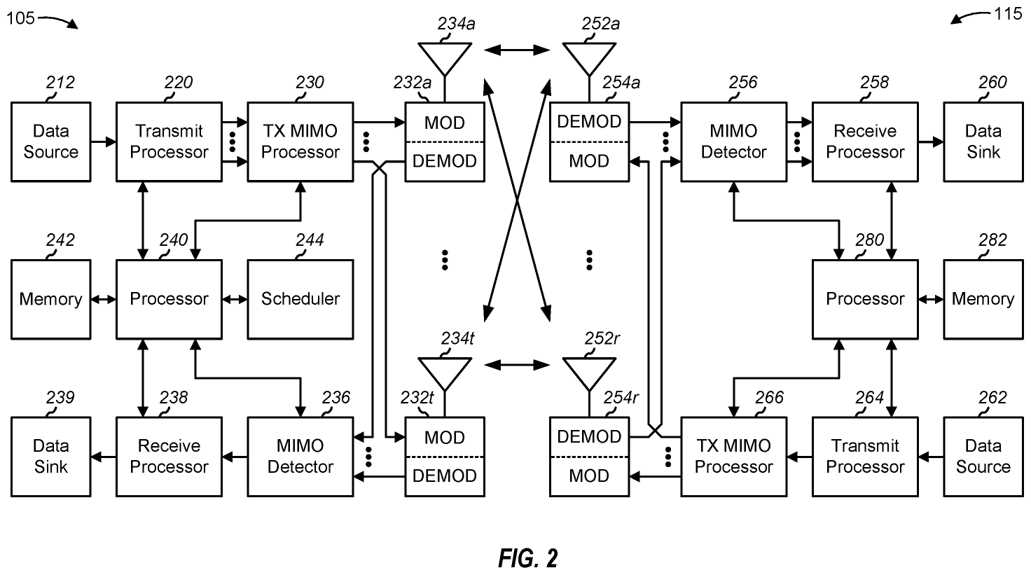

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280.

On the uplink, at UE 115, transmit processor 264 may receive and process data (e.g., for a physical uplink shared channel (PUSCH)) from data source 262 and control information (e.g., for a physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

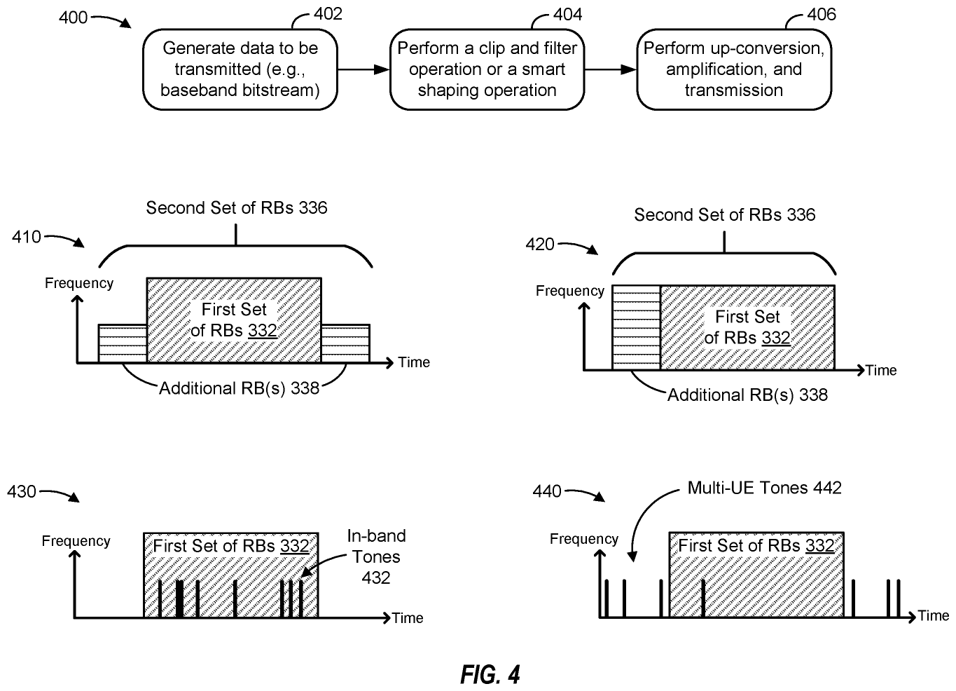

Processors 240 and 280 may direct the operation at base station 105 and UE 115, respectively. Processor 240 or other processors and modules at base station 105 or processor 280 or other processors and modules at UE 115 may perform or direct the execution of various processes for the techniques described herein, such as to perform or direct the operations illustrated in FIGS. 4, 6, and 7, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

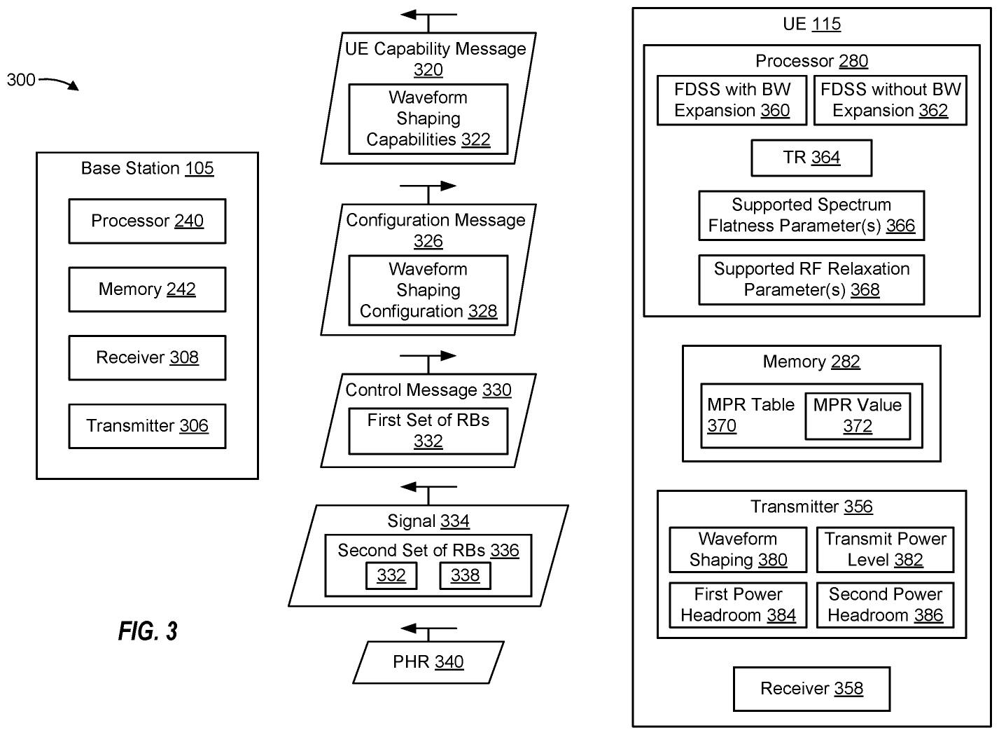

FIG. 3 is a block diagram illustrating an example of a wireless communication system 300 that supports waveform shaping according to some aspects of the disclosure. The wireless communication system 300 may include one or more base stations, such as the base station 105. The wireless communication system 300 may include one or more UEs, such as the UE 115.

The base station 105 may include one or more processors (such as the processor 240), one or more memories (such as the memory 242), a transmitter 306, and a receiver 308. The processor 240 may be coupled to the memory 242, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 306 and the receiver 308 may be integrated in one or more transceivers of the base station 105.

The transmitter 306 may be configured to transmit reference signals, synchronization signals, control information, and data to one or more other devices, and the receiver 308 may be configured to receive reference signals, control information, and data from one or more other devices. For example, the transmitter 306 may be configured to transmit signaling, control information, and data to the UE 115, and the receiver 308 may be configured to receive signaling, control information, and data from the UE 115.

The UE 115 may include one or more processors (such as the processor 280), a memory (such as the memory 282), a transmitter 356, and a receiver 358. The processor 280 may be coupled to the memory 282, to the transmitter 356, and to the receiver 358. In some examples, the transmitter 356 and the receiver 358 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356 and the receiver 358 may be integrated in one or more transceivers of the UE 115.

The transmitter 356 may transmit reference signals, synchronization signals, control information, and data to one or more other devices, and the receiver 358 may receive reference signals, control information, and data from one or more other devices. For example, in some implementations, the transmitter 356 may transmit signaling, control information, and data to the base station 105, and the receiver 358 may receive signaling, control information, and data from the base station 105.

The wireless communication system 300 may use wireless communication channels, which may be specified by one or more wireless communication protocols, such as a 5G NR wireless communication protocol. To illustrate, the base station 105 may communicate with the UE 115 using one or more downlink wireless communication channels (such as via one or more of a PDSCH or a PDCCH). The UE 115 may communicate with the base station 105 using one or more uplink wireless communication channels (such as via one or more of a PUSCH or a PUCCH). Alternatively or in addition, the UE 115 may communicate with one or more other UEs, such as via a sidelink wireless communication channel.

During operation, the UE 115 may transmit signals to one or more other devices and may receive signals from one or more other devices. The one or more other devices may include one or more of the base station 105, another UE, or another device. In some circumstances, a signal transmitted by the UE 115 may have a waveform that is relatively difficult for the UE 115 to generate. For example, a signal may have a relatively large dynamic range, which may result in distortion of the signal, such as by causing saturation during amplification of the signal by a power amplifier of the transmitter 356. Distortion and other effects in the signal may reduce ability of the base station 105 (or other device) to receive the signal. As referred to herein, “waveform” may refer to an wireless signal output by an antenna, such as any of the antennas 252a-r of FIG. 2.

To reduce distortion or other effects in such signals, some wireless communication protocols may specify maximum power reduction (MPR) values, such as an MPR table 370. The UE 115 may use MPR values of the MPR table 370 to reduce a transmit power level of the signals, which may reduce distortion or other effects (such as by reducing power amplifier saturation). Use of the MPR values may reduce range and communication capability of the UE 115 by reducing transmit power of the signals.

In some aspects of the disclosure, the UE 115 may perform waveform shaping 380 of a signal to reduce such distortion or other effects in the signal. The waveform shaping 380 may include adding “excess” bandwidth, resources, tones, or resource blocks (RBs) to a signal. Performing the waveform shaping 380 may modify the waveform of the signal so that the signal is “easier” to transmit, such as by reducing a peak-to-average power ratio (PAPR) of the signal. As a result, performing the waveform shaping 380 may enable the UE 115 to reduce an amount of MPR applied to the signal, increasing range of the signal and communication capability of the UE 115.

In some implementations, the UE 115 may transmit a UE capability message 320 indicating one or more waveform shaping capabilities 322 of the UE 115. To illustrate, the one or more waveform shaping capabilities 322 may include one or more of frequency domain spectrum shaping (FDSS) with bandwidth (BW) expansion 360, FDSS without BW expansion 362, tone reservation (TR) 364, one or more supported spectrum flatness parameters 366, one or more supported radio frequency (RF) relaxation parameters 368, or one or more other capabilities of the UE 115.

The UE 115 may transmit the UE capability message 320 to the base station 105. The base station 105 may receive the UE capability message 320 and may determine a waveform shaping configuration 328 for the UE 115 based on the waveform shaping capabilities 322. To illustrate, the waveform shaping configuration 328 may indicate configuration of the UE 115 with one or more of the FDSS with BW expansion 360, the FDSS without BW expansion 362, the TR 364, an excess BW for the waveform shaping 380, one or more configured spectrum flatness parameters (which may be selected from or may be based on the one or more supported spectrum flatness parameters 366), one or more configured RF relaxation parameters (which may be selected from or may be based on the one or more supported RF relaxation parameters 368), or one or more other parameters.

The base station 105 may transmit a configuration message 326 to the UE 115 indicating the waveform shaping configuration 328. The UE 115 may receive the configuration message 326. In some examples, the base station 105 may dynamically signal the configuration message 326 to the UE 115. For example, the base station 105 may dynamically signal the configuration message 326 to the UE 115 via downlink control information (DCI), via an activation DCI, or via radio resource control (RRC) signaling. To further illustrate, the RRC signaling and the activation DCI may be used in connection with a configurated grant (CG) PUSCH configuration in some implementations.

The UE 115 may apply the waveform shaping configuration 328 to one or more signals transmitted by the UE 115, such as an uplink signal transmitted via an uplink channel or a sidelink signal transmitted via a sidelink channel. To illustrate, the UE 115 may transmit a signal 334 (e.g., to the base station 105) having a waveform that is shaped based on the waveform shaping configuration 328. In some examples, the transmitter 356 may perform, based on the waveform shaping configuration 328, the waveform shaping 380 of the signal 334 prior to transmitting the signal 334. In some examples, the signal 334 may correspond to a PUSCH signal, a PUCCH signal, or another signal (such as a sidelink signal transmitted to another UE).

In some implementations, the UE 115 may selectively perform the waveform shaping 380 based on a waveform type associated with the signal 334. For example, the UE 115 may apply the waveform shaping 380 to the signal 334 based on the waveform type associated with the signal 334 being a relatively difficult waveform for the transmitter 356 to generate. As an illustrative example, in some implementations, a signal having a discrete Fourier transform spread orthogonal frequency division multiplexing (DFT-s-OFDM) waveform type or a cyclic prefix orthogonal frequency division multiplexing (CP-OFDM) waveform type may be relatively difficult for the transmitter 356 to generate. In some such examples, the UE 115 may apply the waveform shaping 380 to the signal 334 based on the signal 334 having a DFT-s-OFDM waveform type or a CP-OFDM waveform type. Further, certain resource allocation types and certain modulation types may be associated with more difficult to transmit waveforms. For example, a higher-order modulation scheme (such as a 256 quadrature amplitude modulation (QAM) scheme) may be more difficult to transmit than a lower-order modulation scheme (such as a 4 QAM scheme). In some such examples, the UE 115 may selectively perform the waveform shaping 380 for a relatively difficult waveform to generate (such as a 256 QAM scheme) and may not perform the waveform shaping 380 for a less difficult waveform to generate (such as a 4 QAM scheme). It is noted that such examples are provided for illustration and that other examples are also within the scope of the disclosure. For example, the “difficulty” of generating a waveform may depend on the particular implementation, such as characteristics of the transmitter 356 (e.g., power amplifier capabilities) and other characteristics.

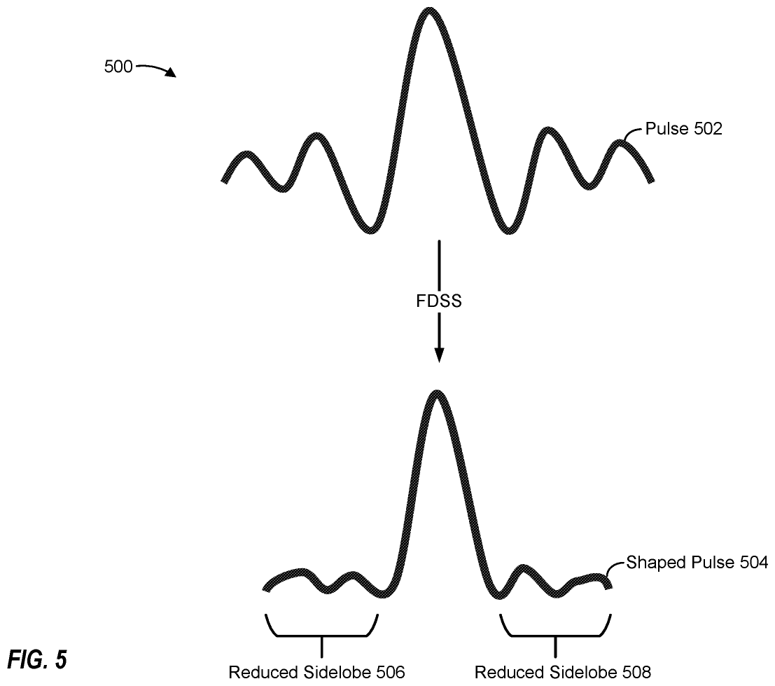

In some examples, the waveform shaping configuration 328 may indicate the FDSS with BW expansion 360, and performing the waveform shaping 380 may include shaping the signal 334 and adding BW to the signal 334 in accordance with the FDSS with BW expansion 360. For example, the UE 115 may add RBs, tones, or BW to the signal 334 to reduce peaks of the signal 334 (such as described with reference to FIG. 4) and may shape the signal 334 to reduce sidelobes of the signal 334 (such as described with reference to FIG. 5).

In some other examples, the waveform shaping configuration 328 may indicate the FDSS without BW expansion 362, and performing the waveform shaping 380 may include shaping the signal 334 in accordance with the FDSS without BW expansion 362. For example, the UE 115 may shape the signal 334 to reduce sidelobes of the signal 334 (such as described with reference to FIG. 5) without adding BW to the signal 334. In some implementations, the FDSS without BW expansion 362 may be applicable to a particular group of modulation schemes, such as quadrature phase shift keying (QPSK), as an illustrative example.

In some examples, the waveform shaping configuration 328 may indicate the TR 364. In such examples, performing the waveform shaping 380 may include performing the TR 364, such as by adding RBs, tones, or BW to the signal 334 (e.g., as described with reference to FIG. 4). In some examples, the TR 364 may also be referred to as, or may share characteristics with, other schemes. For example, the TR 364 may also be referred to as, or may share characteristics with, an excess BW scheme, an excess tone scheme, an excess RB scheme, a BW expansion scheme, waveform shaping, a coverage enhancement scheme, a spectrum extension scheme, or a peak cancelation scheme.

In some examples, the waveform shaping configuration 328 may indicate an excess BW for the waveform shaping 380. The excess BW may be indicated as a percentage (e.g., to increase the first set of RBs 332 by a particular percentage) or as an “absolute” value (e.g., to increase the first set of RBs 332 by a particular quantity of RBs). In some examples, the particular percentage may be expressed as a, a quantity of RBs included in the first set of RBs 332 may be expressed as L, and the UE 115 may determine an amount of excess BW to be added to the signal 334 in accordance with ceil(a*L), where ceil indicates a ceiling function. Performing the waveform shaping 380 may include adding the amount of excess BW to the signal 334.

In some examples, the waveform shaping configuration 328 may indicate at least one selected spectrum flatness parameter of the one or more supported spectrum flatness parameters 366. The UE 115 may perform the waveform shaping 380 in accordance with the at least one selected spectrum flatness parameter. For example, the at least one selected spectrum flatness parameter may “relax” a power spectral density (PSD) parameter of the signal 334 (e.g., so that the signal 334 has a PSD that is less evenly distributed or less “flat”). Performing the waveform shaping 380 may include shaping the signal 334 so that the signal 334 complies with the at least one selected spectrum flatness parameter (e.g., so that the signal 334 has no more than the specified level of entropy).

In some examples, the waveform shaping configuration 328 may indicate at least one selected RF relaxation parameter of the one or more supported RF relaxation parameters 368. The UE 115 may perform the waveform shaping 380 in accordance with the at least one selected RF relaxation parameter. To illustrate, the at least one selected RF relaxation parameter may specify that the UE 115 may perform an in-band emission (IBE) operation, which may include “polluting” the signal 334, tones of the signal 334, or tones adjacent to the signal 334 (e.g., by adding noise or other signal components to the signal 334). In such examples, performing the waveform shaping 380 may include performing RF relaxation based on the at least one selected RF relaxation parameter, such as by “polluting” the signal 334 with noise or other signal components.

The signal 334 may have a transmit power level 382 that is selected in accordance with the waveform shaping configuration 328. To illustrate, without performing the waveform shaping 380, one or more characteristics (such as one or more of a dynamic range or a PAPR) of the signal 334 may be associated with signal distortion, and the UE 115 may be configured with an MPR value 372 to reduce effects of the signal distortion. In such examples, a UE transmitting the signal 334 without performing the waveform shaping configuration 328 may use the MPR value 372 to attenuate the signal 334 to reduce effects of the signal distortion. By transmitting the signal 334 in accordance with the waveform shaping configuration 328, the UE 115 may reduce a PAPR associated with the signal 334, and the reduced PAPR may enable the UE 115 to reduce the MPR value 372 (or to avoid use of the MPR value 372), resulting in the transmit power level 382. To illustrate, use of one or more of the FDSS with BW expansion 360, the FDSS without BW expansion 362, the TR 364, the one or more supported spectrum flatness parameters 366, or the one or more supported RF relaxation parameters 368 may reduce a PAPR associated with the signal 334. As a result, the transmit power level 382 may be greater than a transmit power level used by another UE 115 to transmit the signal without performing the waveform shaping 380 (and based on the MPR value 372). In some examples, the transmit power level 382 is greater than a second transmit power level 382 that corresponds to a “maximum” transmit power of the UE 115 minus the MPR value 372.

In some implementations, the UE 115 may adjust one or more of the MPR value 372 or the transmit power level 382 based on a particular quantity of RBs associated with the signal 334 (such as a quantity of actual or allocated RBs of the signal 334) being relatively small. For example, if the particular quantity of RBs is less than a threshold quantity of RBs, the UE 115 may further reduce the MPR value 372 or may select another MPR value 372 from the MPR table 370 that is less than the MPR value 372. Alternatively or in addition, the UE 115 may increase the transmit power level 382. In some examples, the waveform shaping configuration 328 may be associated with or may specify the threshold quantity of RBs, and in response to the particular quantity of RBs being less than the threshold quantity of RBs, the UE 115 may perform one or more of selecting another MPR value less than the MPR value 372 (e.g., from the MPR table 370) or increasing the transmit power level 382.

In some examples, the UE 115 may indicate one or more transmit power level capabilities for each of the one or more waveform shaping capabilities 322. For example, the UE capability message 320 (or another message) may indicate, for each of the one or more waveform shaping capabilities 322, a respective transmit power level capability associated with the waveform shaping capability. To illustrate, the UE capability message 320 may indicate a respective transmit power level capability for one or more of the FDSS with BW expansion 360, the FDSS without BW expansion 362, the TR 364, the one or more supported spectrum flatness parameters 366, or the one or more supported RF relaxation parameters 368. In some examples, each transmit power level capability may be expressed in decibels (dB), which may be selected from a set of values (e.g., 0.5 dB, 1 dB, 1.5 dB, or other values, etc.) specified by a wireless communication protocol. Each transmit power level capability may indicate an amount of additional power, after performing the waveform shaping 380, that the UE 115 is capable of delivering above a reference power level, such as a power class associated with the UE 115.

In some examples, the UE 115 may indicate the transmit power level capabilities based on parameters indicated by the base station 105. For example, the waveform shaping configuration 328 may indicate multiple sets of IBE parameters, and the UE 115 may report to the base station 105 transmit power level capabilities for each set of the multiple sets of IBE parameters.

In some implementations, the UE 115 may transmit a power headroom report (PHR) 340 in accordance with the waveform shaping configuration 328. To illustrate, prior to activation of the waveform shaping configuration 328, the UE 115 may support a first power headroom 384 for uplink transmissions, and after activation of the waveform shaping configuration 328, the UE 115 may support a second power headroom 386 for the uplink transmissions different than the first power headroom 384. The PHR 340 may indicate a difference between the first power headroom 384 and the second power headroom 386.

In some examples, the base station 105 may transmit a control message 330 to the UE 115. The control message 330 may configure the UE 115 with a first set of RBs 332 for the signal 334. After performing the waveform shaping 380, the UE 115 may transmit the signal 334 using a second set of RBs 336 that includes the first set of RBs 332 and that further includes one or more additional RBs 338. In such examples, performing the waveform shaping 380 may include “adding” the one or more additional RBs 338 to the first set of RBs 332. The first set of RBs 332 may be referred to as allocated RBs, and the second set of RBs 336 may be referred to as “actual” RBs, and the one or more additional RBs 338 may be referred to as “excess” RBs.

In some implementations, the waveform shaping configuration 328 may specify the one or more additional RBs 338. In some other examples, the base station 105 may indicate a plurality of sets of additional RBs (e.g., via the waveform shaping configuration 328) and may subsequently indicate selection of the one or more additional RBs 338 from among the plurality of sets of additional RBs. As a non-limiting example, the waveform shaping configuration 328 may indicate four values, where the one or more additional RBs 338 correspond to increases of the first set of RBs 332 of twenty-five percent, fifty percent, seventy-five percent, or one-hundred percent. In such examples, the second set of RBs 336 may include either 1.25 times, 1.5 times, 1.75 times, or 2.0 times the quantity of RBs included in the first set of RBs 332. In some examples, the base station 105 may configure the UE 115 via RRC signaling with the plurality of sets of additional RBs and may subsequently activate one of the sets of additional RBs via DCI.

In some examples, the UE 115 may indicate the base station 105 a particular quantity of RBs (e.g., excess RBs) supported by the UE 115 for the waveform shaping 380. For example, in some implementations, one or more characteristics of the transmitter 356 may determine the particular quantity of RBs. The one or more characteristics may include a quantity or type of filters of the transmitter 356, as an illustrative example. In some examples, the UE capability message 320 may indicate the particular quantity of RBs associated with the waveform shaping 380. In an illustrative example, the particular quantity of RBs may correspond to five RBs, ten RBs, twenty RBs, or another quantity of RBs. In some such examples, the first set of RBs 332 may be increased by five RBs, ten RBs, twenty RBs, or another quantity of RBs to generate the second set of RBs 336.

Alternatively or in addition, the UE capability message 320 may indicate a quantity of BW associated with the waveform shaping 380. In some examples, the quantity of BW may be expressed as a percentage. To illustrate, the quantity of BW may correspond to twenty-five percent or another percentage. In some such examples, a bandwidth of the first set of RBs 332 may be increased by twenty-five percent or another percentage to generate the second set of RBs 336.

Some wireless communication protocols may specify that the UE 115 is to perform one or more operations based on a set of RBs associated with the signal 334. For example, a wireless communication protocol may specify that the UE 115 is to compute a particular metric or parameter based on the set of RBs associated with the signal 334. In some aspects of the disclosure, the set of RBs may be selected from among the first set of RBs 332 (e.g., the “allocated” set of RBs of the signal 334) or the second set of RBs 336 (e.g., the “actual” set of RBs of the signal 334).

To illustrate, in some examples, the UE 115 may perform an uplink control information (UCI) multiplexing operation that includes multiplexing an uplink control channel transmission with an uplink data channel transmission (e.g., to generate the signal 334). The UE 115 may perform the UCI multiplexing operation in accordance with the first set of RBs 332 instead of the second set of RBs 336. Alternatively or in addition, the UE 115 may perform a power control operation in accordance with the first set of RBs 332 instead of the second set of RBs 336. Alternatively or in addition, the UE 115 may transmit a reference signal with the signal 334 in accordance with the first set of RBs 332 instead of the second set of RBs 336. In some examples, the reference signal may correspond to a demodulation reference signal (DMRS) or a phase tracking reference signal (PTRS).

In some other examples, the base station 105 may configure the UE 115 with a particular reference signal configuration for use when performing the waveform shaping 380. To illustrate, the UE 115 may receive an indication of a particular DMRS configuration for use in response to receiving the waveform shaping configuration 328. In this case, the UE 115 may transmit a DMRS with the signal 334, and the DMRS may have the particular DMRS configuration. In another example, the UE 115 may receive an indication of a particular PTRS configuration for use in response to receiving the waveform shaping configuration. In this case, the UE 115 may transmit a PTRS with the signal 334, and the PTRS may have the particular PTRS configuration.

In some other examples, the UE 115 may avoid transmitting a reference signal in response to performing the waveform shaping 380, such as to avoid interference between the reference signal and the signal 334. In such examples, in response to receiving the waveform shaping configuration 328, the UE 115 may transmit the signal 334 without transmitting a PTRS associated with the signal 334.

The base station 105 may receive the signal 334. The base station 105 may process the signal 334 in accordance with the waveform shaping configuration 328. For example, the base station 105 may remove or discard the one or more additional RBs 338 from the signal 334 and may process remaining data tones of the signal 334 after removing or discarding the one or more additional RBs 338. In some implementations, after receiving the signal 334, the base station 105 may reassign the one or more additional RBs 338 to another transmission (such as to another transmission by the UE 115 or by another UE).

The base station 105 may receive the PHR 340. In some examples, the base station 105 may adjust the waveform shaping configuration 328 based on the PHR 340. For example, if the PHR 340 indicates that another waveform shaping configuration 328 may result in a greater transmit power level 382, the base station 105 may transmit another configuration message 326 to the UE 115 configuring the UE 115 with the other waveform shaping configuration 328.

FIG. 4 depicts examples of operations that may support waveform shaping according to one or more aspects. FIG. 4 illustrates an example of a process 400. In some examples, the UE 115 may perform the process 400.

The process 400 includes generating data to be transmitted, at 402. For example, the data may include a baseband bitstream associated with the signal 334.

The process 400 may further include performing a clip and filter operation or a smart shaping operation, at 404. For example, the UE 115 may perform the clip and filter operation or the smart shaping operation in connection with digital-to-analog conversion associated with the signal 334.

The process 400 may further include performing up-conversion, amplification, and transmission, at 406. For example, the UE 115 may up-convert, amplify (e.g., using a power amplifier of the transmitter 356), and transmit the signal 334.

In some circumstances, the clip and filter operation and the smart shaping operation may be associated with noise, such as clipping noise and shaping noise, respectively. Such noise may reduce ability of a device (such as the base station 105) to receive the signal 334. To reduce effects of the noise, the UE 115 may redirect the noise to one or more bandwidth areas associated with the signal 334. To redirect the noise to the one or more bandwidth areas, the UE 115 may perform the TR 364.

FIG. 4 depicts illustrative examples of TR schemes 410, 420, 430, and 440. In some examples, the UE 115 may use one or more features of TR schemes 410, 420, 430, and 440 in connection with the TR 364. In the TR scheme 410, additional RBs 338 are added to each side of the first set of RBs 332 to form the second set of RBs 336. In the TR scheme 420, one or more additional RBs 338 are added to a side of the first set of RBs 332 to form the second set of RBs 336. In the TR scheme 430, in-band tones 432 are generated in-band with respect to the first set of RBs 332. In the TR scheme 440, multi-UE tones 442 are generated in-band and out-of-band with respect to the first set of RBs 332. The multi-UE tones 442 may correspond to a “universal” TR sequence used by multiple UEs (including the UE 115). Further, in some applications, the tones 432, 442 may be referred to as peak reduction tones (PRTs). The tones 432, 442 may include resources associated with the one or more additional RBs 338.

Use of the TR schemes 410, 420, 430, and 440 may enable peak reduction or peak cancelation associated with the signal 334, which may lower a PAPR associated with the signal 334. Further, upon receiving the signal 334, the base station 105 may discard the one or more additional RBs 338 or the tones 432,442 from the signal 334 and may process remaining data tones of the signal 334. In some implementations, the base station 105 may reassign the one or more additional RBs 338, the tones 432, 442, or other “excess” resources for another transmission.

FIG. 5 depicts an example of an FDSS operation 500 that may support waveform shaping according to one or more aspects. In some examples, the FDSS operation 500 may correspond to or may be included in one or both of the FDSS with BW expansion 360 or the FDSS without BW expansion 362 of FIG. 3.

The FDSS operation 500 illustrates an example of a pulse 502. In FIG. 5, the pulse 502 may be represented in the frequency domain. The pulse 502 may also be referred to as a tone.

In the FDSS operation 500 of FIG. 5, a pulse 502 associated with the signal 334 may be modified (e.g., pulse-shaped or filtered) to generate a shaped pulse 504. In some examples, the modifying the pulse 502 may include filtering a discrete Fourier transform (DFT) output associated with the signal 334 with frequency domain filter coefficients. The filter coefficients may correspond to Hann windowing filter coefficients, Hamming filter coefficients, root-raised-cosine (RRC) filter coefficients, or other filter coefficients, as illustrative examples. In some examples, modifying the pulse 502 may also include tone insertion, such as by inserting one or more tones in the DFT output. The UE 115 may generate a time domain representation of the signal 334 by performing an inverse DFT (IDFT) operation based on the DFT output (such as after performing filtering, tone insertion, or both).

The shaped pulse 504 may include reduced sidelobes 506, 508 as compared to the pulse 502. As a result of the reduced sidelobes 506, 508, the shaped pulse 504 may be less likely than the pulse 502 to interfere with other components of the signal 334. For example, as a result of the reduced sidelobes 506, 508, the shaped pulse 504 may experience less sidelobe overlap with a subsequent pulse of the signal 334 following the shaped pulse 504.

Although certain examples have been described herein with reference to communications between the UE 115 and the base station 105, other examples are also within the scope of the disclosure. For example, one or more operations described herein may be performed between the UE 115 and one or more other UEs. To further illustrate, in some examples, the UE 115 may transmit the signal 334 to another UE via a sidelink communication channel. As another example, in some implementations, waveform shaping may be performed by the base station 105 (alternatively or in addition to the UE 115).

One or more aspects described herein may improve performance within a wireless communication system, such as the wireless communication system 300. For example, by performing the waveform shaping 380, the UE 115 may avoid or reduce an amount of MPR applied to a signal, such as where the transmit power level 382 is less than a transmit power level associated with the MPR value 372. As a result, the transmit power level 382 may be increased, increasing range of the signal 334 and communication capability of the UE 115 as compared to other techniques, such as techniques that use the MPR value 372 (or a “full” MPR value 372). Further, the UE 115 may avoid certain circuitry associated with reduction of distortion and other effects, which may reduce device cost, power consumption, and usage of processing resources.

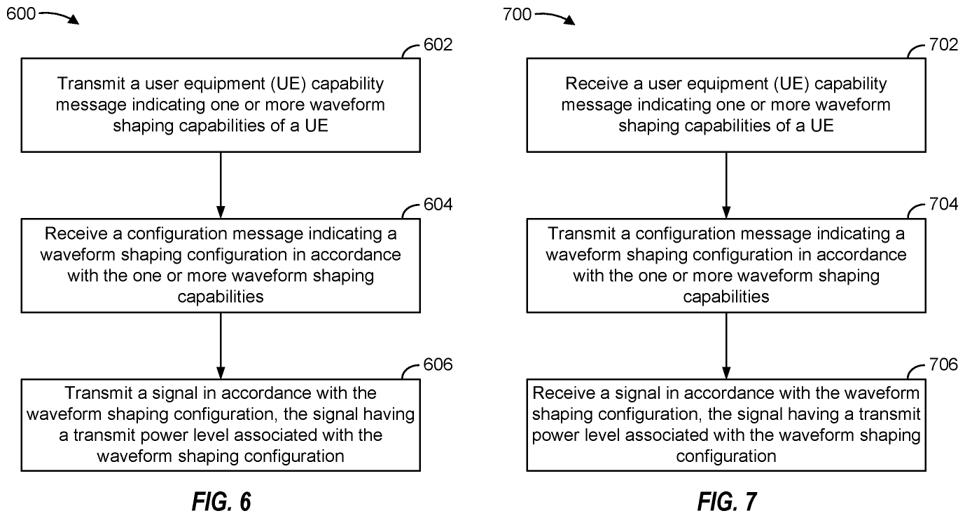

FIG. 6 is a flow diagram illustrating an example process 600 that supports waveform shaping according to one or more aspects. Operations of the process 600 may be performed by a UE, such as the UE 115.

The process 600 includes transmitting a UE capability message indicating one or more waveform shaping capabilities of the UE, at 602. For example, the UE 115 may transmit the UE capability message 320 indicating the one or more waveform shaping capabilities 322.

The process 600 further includes receiving a configuration message indicating a waveform shaping configuration in accordance with the one or more waveform shaping capabilities, at 604. For example, the UE 115 may receive the configuration message 326 indicating the waveform shaping configuration 328.

The process 600 further includes transmitting a signal in accordance with the waveform shaping configuration, at 606. The signal has a transmit power level associated with the waveform shaping configuration. For example, the UE 115 may transmit the signal 334 in accordance with the waveform shaping configuration 328, and the signal 334 may have the transmit power level 382 associated with the waveform shaping configuration 328.

FIG. 7 is a flow diagram illustrating an example process 700 that supports waveform shaping according to one or more aspects. Operations of the process 700 may be performed by network node (e.g., a base station), such as the base station 105.

The process 700 includes receiving a user equipment (UE) capability message indicating one or more waveform shaping capabilities of a UE, at 702. For example, the base station 105 may receive the UE capability message 320 indicating the one or more waveform shaping capabilities 322.

The process 700 further includes transmitting a configuration message indicating a waveform shaping configuration in accordance with the one or more waveform shaping capabilities, at 704. For example, the base station 105 may transmit the configuration message 326 indicating the waveform shaping configuration 328.

The process 700 further includes receiving a signal in accordance with the waveform shaping configuration, at 706. The signal has a transmit power level associated with the waveform shaping configuration. For example, the base station 105 may receive the signal 334 in accordance with the waveform shaping configuration 328, and the signal 334 may have the transmit power level 382 associated with the waveform shaping configuration 328.

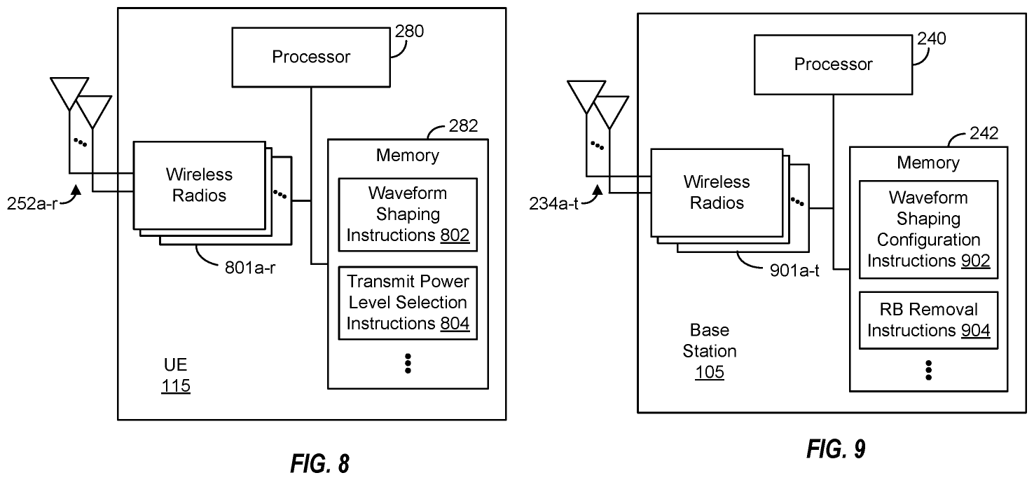

FIG. 8 is a block diagram illustrating an example of the UE 115 according to some aspects of the disclosure. The UE 115 may include structure, hardware, or components illustrated in FIG. 2. For example, the UE 115 may include the processor 280, which may execute instructions stored in the memory 282. Using the processor 280, the UE 115 may transmit and receive signals via wireless radios 801a-r and antennas 252a-r. The wireless radios 801a-r may include one or more components or devices described herein, such as the modulator/demodulators 254a-r, the MIMO detector 256, the receive processor 258, the transmit processor 264, the TX MIMO processor 266, the transmitter 356, the receiver 358, one or more other components or devices, or a combination thereof.

In some examples, the memory 282 may store instructions executable by one or more processors (such as the processor 280) to initiate, perform, or control one or more operations described herein. For example, the memory 282 may store waveform shaping instructions 802 executable by the processor 280 to initiate, perform, or control the waveform shaping 380 of the signal 334 based on the waveform shaping configuration 328. As another example, the memory 282 may store transmit power level selection instructions 804 executable by the processor 280 to select the transmit power level 382 of the signal 334 based on the waveform shaping configuration 328.

FIG. 9 is a block diagram illustrating an example of the base station 105 according to some aspects of the disclosure. The base station 105 may include structure, hardware, and components illustrated in FIG. 2. For example, the base station 105 may include the processor 240, which may execute instructions stored in memory 242. Under control of the processor 240, the base station 105 may transmit and receive signals via wireless radios 901a-t and antennas 234a-t. The wireless radios 901a-t may include one or more components or devices described herein, such as the modulator/demodulators 232a-t, the MIMO detector 236, the receive processor 238, the transmit processor 220, the TX MIMO processor 230, the transmitter 306, the receiver 308, one or more other components or devices, or a combination thereof.

In some examples, the memory 242 may store instructions executable by one or more processors (such as the processor 240) to initiate, perform, or control one or more operations described herein. For example, the memory 242 may store waveform shaping configuration instructions 902 executable by the processor 240 to configure with the waveform shaping configuration 328, such as via the configuration message 326. As another example, the memory 242 may store RB removal instructions 904 executable to remove the one or more additional RBs 338 from the signal 334.

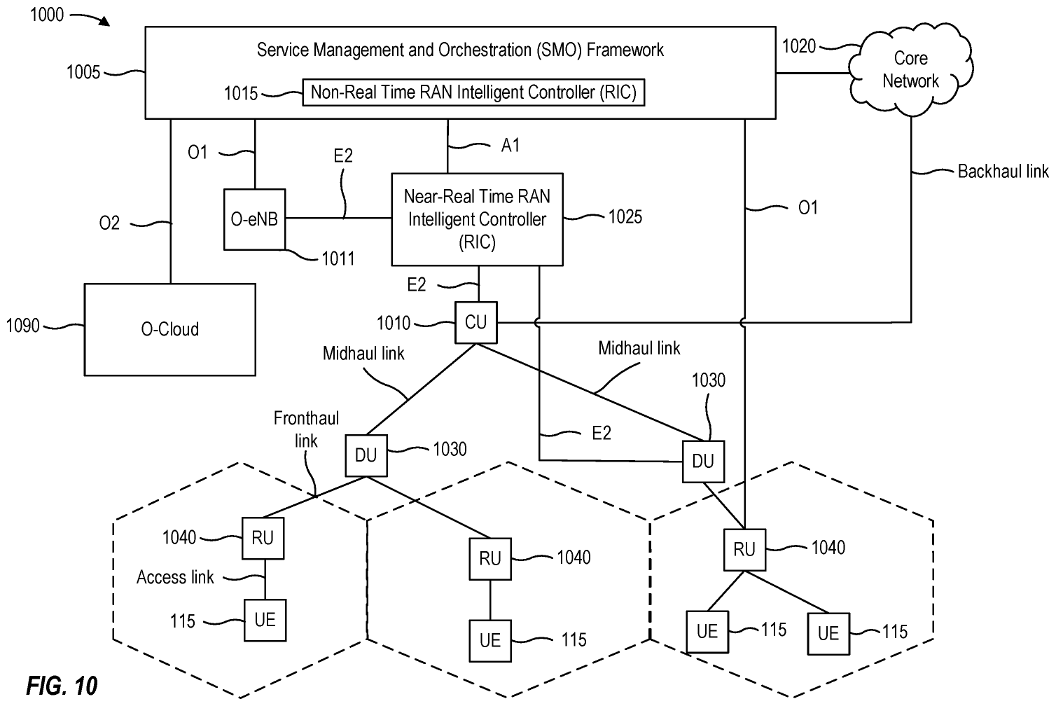

FIG. 10 shows a diagram illustrating an example disaggregated base station 1000 architecture according to some aspects of the disclosure. In some examples, the disaggregated base station 1000 architecture may be used to implement the base station 105. The disaggregated base station 1000 architecture may include one or more central units (CUs) 1010 that can communicate directly with a core network 1020 via a backhaul link, or indirectly with the core network 1020 through one or more disaggregated base station units (such as a Near-Real Time (Near-RT) RAN Intelligent Controller (RIC) 1025 via an E2 link, or a Non-Real Time (Non-RT) RIC 1015 associated with a Service Management and Orchestration (SMO) Framework 1005, or both). A CU 1010 may communicate with one or more distributed units (DUs) 1030 via respective midhaul links, such as an F1 interface. The DUs 1030 may communicate with one or more radio units (RUs) 1040 via respective fronthaul links. The RUs 1040 may communicate with respective UEs 115 via one or more radio frequency (RF) access links. In some implementations, the UE 115 may be simultaneously served by multiple RUs 1040.

Each of the units, i.e., the CUs 1010, the DUs 1030, the RUs 1040, as well as the Near-RT RICs 1025, the Non-RT RICs 1015 and the SMO Framework 1005, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1010 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1010. The CU 1010 may be configured to handle user plane functionality (i.e., Central Unit-User Plane (CU-UP)), control plane functionality (i.e., Central Unit-Control Plane (CU-CP)), or a combination thereof. In some implementations, the CU 1010 can be logically split into one or more CU-UP units and one or more CU-CP units. The CU-UP unit can communicate bidirectionally with the CU-CP unit via an interface, such as the E1 interface when implemented in an O-RAN configuration. The CU 1010 can be implemented to communicate with the DU 1030, as necessary, for network control and signaling.

The DU 1030 may correspond to a logical unit that includes one or more base station functions to control the operation of one or more RUs 1040. In some aspects, the DU 1030 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1030 may further host one or more low PHY layers. Each layer (or module) can be implemented with an interface configured to communicate signals with other layers (and modules) hosted by the DU 1030, or with the control functions hosted by the CU 1010.

Lower-layer functionality can be implemented by one or more RUs 1040. In some deployments, an RU 1040, controlled by a DU 1030, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1040 can be implemented to handle over the air (OTA) communication with one or more UEs 115. In some implementations, real-time and non-real-time aspects of control and user plane communication with the RU(s) 1040 can be controlled by the corresponding DU 1030. In some scenarios, this configuration can enable the DU(s) 1030 and the CU 1010 to be implemented in a cloud-based RAN architecture, such as a vRAN architecture.

The SMO Framework 1005 may be configured to support RAN deployment and provisioning of non-virtualized and virtualized network elements. For non-virtualized network elements, the SMO Framework 1005 may be configured to support the deployment of dedicated physical resources for RAN coverage requirements which may be managed via an operations and maintenance interface (such as an O1 interface). For virtualized network elements, the SMO Framework 1005 may be configured to interact with a cloud computing platform (such as an open cloud (O-Cloud) 1090) to perform network element life cycle management (such as to instantiate virtualized network elements) via a cloud computing platform interface (such as an O2 interface). Such virtualized network elements can include, but are not limited to, CUs 1010, DUs 1030, RUs 1040 and Near-RT RICs 1025. In some implementations, the SMO Framework 1005 can communicate with a hardware aspect of a 4G RAN, such as an open eNB (O-eNB) 1011, via an O1 interface. Additionally, in some implementations, the SMO Framework 1005 can communicate directly with one or more RUs 1040 via an O1 interface. The SMO Framework 1005 also may include a Non-RT RIC 1015 configured to support functionality of the SMO Framework 1005.

The Non-RT RIC 1015 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1025. The Non-RT RIC 1015 may be coupled to or communicate with (such as via an A1 interface) the Near-RT RIC 1025. The Near-RT RIC 1025 may be configured to include a logical function that enables near-real-time control and optimization of RAN elements and resources via data collection and actions over an interface (such as via an E2 interface) connecting one or more CUs 1010, one or more DUs 1030, or both, as well as an O-eNB, with the Near-RT RIC 1025.

In some implementations, to generate AI/ML models to be deployed in the Near-RT RIC 1025, the Non-RT RIC 1015 may receive parameters or external enrichment information from external servers. Such information may be utilized by the Near-RT RIC 1025 and may be received at the SMO Framework 1005 or the Non-RT RIC 1015 from non-network data sources or from network functions. In some examples, the Non-RT RIC 1015 or the Near-RT RIC 1025 may be configured to tune RAN behavior or performance. For example, the Non-RT RIC 1015 may monitor long-term trends and patterns for performance and employ AI/ML models to perform corrective actions through the SMO Framework 1005 (such as reconfiguration via O1) or via creation of RAN management policies (such as A1 policies).

According to some further aspects, in a first aspect, an apparatus for wireless communication by a UE includes a transmitter configured to transmit a UE capability message indicating one or more waveform shaping capabilities of the UE. The apparatus further includes a receiver configured to receive a configuration message indicating a waveform shaping configuration in accordance with the one or more waveform shaping capabilities. The transmitter is further configured to transmit a signal in accordance with the waveform shaping configuration. The signal has a transmit power level associated with the waveform shaping configuration.

In a second aspect in combination with the first aspect, the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

In a third aspect in combination with one or more of the first through second aspects, the UE capability message further indicates, for each of the one or more waveform shaping capabilities, a respective transmit power level capability associated with the waveform shaping capability.

In a fourth aspect in combination with one or more of the first through third aspects, the UE capability message further indicates one or more of a particular quantity of resource blocks (RBs) associated with the waveform shaping or a quantity of bandwidth (BW) associated with the waveform shaping.

In a fifth aspect in combination with one or more of the first through fourth aspects, the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

In a sixth aspect in combination with one or more of the first through fifth aspects, the receiver is further configured to receive the configuration message dynamically via downlink control information (DCI), via an activation DCI, or via radio resource control (RRC) signaling.

In a seventh aspect in combination with one or more of the first through sixth aspects, the transmitter is further configured to transmit a power headroom report (PHR) in accordance with the waveform shaping configuration.

In an eighth aspect in combination with one or more of the first through seventh aspects, the UE is configured to support a first power headroom for uplink transmissions prior to activation of the waveform shaping configuration, and the UE is further configured to support a second power headroom for the uplink transmissions different than the first power headroom after activation of the waveform shaping configuration.

In a ninth aspect in combination with one or more of the first through eighth aspects, the PHR indicates a difference between the first power headroom and the second power headroom.

In a tenth aspect in combination with one or more of the first through ninth aspects, the receiver is further configured to receive a control message configuring the UE with a first set of resource blocks (RBs) for the signal, and the transmitter is further configured to transmit the signal using a second set of RBs that includes the first set of RBs and that further includes one or more additional RBs specified by the waveform shaping configuration.

In an eleventh aspect in combination with one or more of the first through tenth aspects, the waveform shaping configuration indicates a plurality of sets of additional RBs, and the receiver is further configured to receive an indication of selection of the one or more additional RBs from among the plurality of sets of additional RBs.

In a twelfth aspect in combination with one or more of the first through eleventh aspects, the transmitter is further configured to perform, in accordance with the first set of RBs instead of the second set of RBs, an uplink control information (UCI) multiplexing operation that includes multiplexing an uplink control channel transmission with an uplink data channel transmission.

In a thirteenth aspect in combination with one or more of the first through twelfth aspects, the UE is further configured to perform a power control operation in accordance with the first set of RBs instead of the second set of RBs.

In a fourteenth aspect in combination with one or more of the first through thirteenth aspects, the transmitter is further configured to transmit a demodulation reference signal (DMRS) with the signal in accordance with the first set of RBs instead of the second set of RBs.

In a fifteenth aspect in combination with one or more of the first through fourteenth aspects, the receiver is further configured to receive an indication of a particular demodulation reference signal (DMRS) configuration for use in response to receiving the waveform shaping configuration, and the transmitter is further configured to transmit a DMRS with the signal, the DMRS having the particular DMRS configuration.

In a sixteenth aspect in combination with one or more of the first through fifteenth aspects, the receiver is further configured to receive an indication of a particular phase tracking reference signal (PTRS) configuration for use in response to receiving the waveform shaping configuration and the transmitter is further configured to transmit a PTRS with the signal, the PTRS having the particular PTRS configuration.

In a seventeenth aspect in combination with one or more of the first through sixteenth aspects, in response to receiving the waveform shaping configuration, the transmitter is further configured to transmit the signal without transmitting a phase tracking reference signal (PTRS) associated with the signal.

In an eighteenth aspect in combination with one or more of the first through seventeenth aspects, one or more characteristics of the signal are associated with signal distortion, and the UE is configured with a maximum power reduction (MPR) value to reduce effects of the signal distortion.

In a nineteenth aspect in combination with one or more of the first through eighteenth aspects, transmission of the signal in accordance with the waveform shaping configuration reduces a peak-to-average power ratio (PAPR) associated with the signal, and the reduced PAPR enables reduction of the MPR value.

In a twentieth aspect in combination with one or more of the first through nineteenth aspects, the waveform shaping configuration is associated with a threshold quantity of resource blocks (RBs), the signal is associated with a particular quantity of RBs, and the UE is further configured to perform, in response to the particular quantity of RBs being less than the threshold quantity of RBs, one or more of selecting another MPR value less than the MPR value or increasing the transmit power level.

In a twenty-first aspect, a method of wireless communication performed by a UE includes transmitting a UE capability message indicating one or more waveform shaping capabilities of the UE. The method further includes receiving a configuration message indicating a waveform shaping configuration in accordance with the one or more waveform shaping capabilities. The method further includes transmitting a signal in accordance with the waveform shaping configuration. The signal has a transmit power level associated with the waveform shaping configuration.

In a twenty-second aspect in combination with the twenty-first aspect, the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

In a twenty-third aspect in combination with one or more of the twenty-first through twenty-second aspects, the UE capability message further indicates, for each of the one or more waveform shaping capabilities, a respective transmit power level capability associated with the waveform shaping capability.

In a twenty-fourth aspect in combination with one or more of the twenty-first through twenty-third aspects, the UE capability message further indicates one or more of a particular quantity of resource blocks (RBs) associated with the waveform shaping or a quantity of bandwidth (BW) associated with the waveform shaping.

In a twenty-fifth aspect in combination with one or more of the twenty-first through twenty-fourth aspects, the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

In a twenty-sixth aspect in combination with one or more of the twenty-first through twenty-fifth aspects, the configuration message is dynamically signaled via downlink control information (DCI), via an activation DCI, or via radio resource control (RRC) signaling.

In a twenty-seventh aspect in combination with one or more of the twenty-first through twenty-sixth aspects, the method includes transmitting a power headroom report (PHR) in accordance with the waveform shaping configuration.

In a twenty-eighth aspect in combination with one or more of the twenty-first through twenty-seventh aspects, prior to activation of the waveform shaping configuration, the UE supports a first power headroom for uplink transmissions, and after activation of the waveform shaping configuration, the UE supports a second power headroom for the uplink transmissions different than the first power headroom.

In a twenty-ninth aspect in combination with one or more of the twenty-first through twenty-eighth aspects, the PHR indicates a difference between the first power headroom and the second power headroom.

In a thirtieth aspect in combination with one or more of the twenty-first through twenty-ninth aspects, the method includes receiving a control message configuring the UE with a first set of resource blocks (RBs) for the signal, where the signal is transmitted using a second set of RBs that includes the first set of RBs and that further includes one or more additional RBs specified by the waveform shaping configuration.

In a thirty-first aspect in combination with one or more of the twenty-first through thirtieth aspects, the waveform shaping configuration indicates a plurality of sets of additional RBs, and the method includes receiving an indication of selection of the one or more additional RBs from among the plurality of sets of additional RBs.

In a thirty-second aspect in combination with one or more of the twenty-first through thirty-first aspects, the method includes performing, in accordance with the first set of RBs instead of the second set of RBs, an uplink control information (UCI) multiplexing operation that includes multiplexing an uplink control channel transmission with an uplink data channel transmission.

In a thirty-third aspect in combination with one or more of the twenty-first through thirty-second aspects, the method includes performing a power control operation in accordance with the first set of RBs instead of the second set of RBs.

In a thirty-fourth aspect in combination with one or more of the twenty-first through thirty-third aspects, the method includes transmitting a demodulation reference signal (DMRS) with the signal, and the DMRS is transmitted in accordance with the first set of RBs instead of the second set of RBs.

In a thirty-fifth aspect in combination with one or more of the twenty-first through thirty-fourth aspects, the method includes receiving an indication of a particular demodulation reference signal (DMRS) configuration for use in response to receiving the waveform shaping configuration and transmitting a DMRS with the signal, the DMRS having the particular DMRS configuration.

In a thirty-sixth aspect in combination with one or more of the twenty-first through thirty-fifth aspects, the method includes receiving an indication of a particular phase tracking reference signal (PTRS) configuration for use in response to receiving the waveform shaping configuration and transmitting a PTRS with the signal, the PTRS having the particular PTRS configuration.

In a thirty-seventh aspect in combination with one or more of the twenty-first through thirty-sixth aspects, in response to receiving the waveform shaping configuration, the UE transmits the signal without transmitting a phase tracking reference signal (PTRS) associated with the signal.

In a thirty-eighth aspect in combination with one or more of the twenty-first through thirty-seventh aspects, one or more characteristics of the signal are associated with signal distortion, and the UE is configured with a maximum power reduction (MPR) value to reduce effects of the signal distortion.

In a thirty-ninth aspect in combination with one or more of the twenty-first through thirty-eighth aspects, transmission of the signal in accordance with the waveform shaping configuration reduces a peak-to-average power ratio (PAPR) associated with the signal, and the reduced PAPR enables reduction of the MPR value.

In a fortieth aspect in combination with one or more of the twenty-first through thirty-ninth aspects, the waveform shaping configuration is associated with a threshold quantity of resource blocks (RBs), the signal is associated with a particular quantity of RBs, and the method includes, in response to the particular quantity of RBs being less than the threshold quantity of RBs, performing one or more of selecting another MPR value less than the MPR value or increasing the transmit power level.

In a forty-first aspect in combination with one or more of the first through fortieth aspects, an apparatus for wireless communication by a network node includes a receiver configured to receive a UE capability message indicating one or more waveform shaping capabilities of a UE. The apparatus further includes a transmitter configured to transmit a configuration message indicating a waveform shaping configuration in accordance with the one or more waveform shaping capabilities. The receiver is further configured to receive a signal in accordance with the waveform shaping configuration. The signal has a transmit power level associated with the waveform shaping configuration.

In a forty-second aspect in combination with the forty-first aspect, the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

In a forty-third aspect in combination with one or more of the forty-first through forty-second aspects, the UE capability message further indicates, for each of the one or more waveform shaping capabilities, a respective transmit power level capability associated with the waveform shaping capability.

In a forty-fourth aspect in combination with one or more of the forty-first through forty-third aspects, the UE capability message further indicates one or more of a particular quantity of resource blocks (RBs) associated with the waveform shaping or a quantity of bandwidth (BW) associated with the waveform shaping.

In a forty-fifth aspect in combination with one or more of the forty-first through forty-fifth aspects, the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

In a forty-sixth aspect in combination with one or more of the forty-first through forty-fifth aspects, the transmitter is further configured to transmit the configuration message dynamically via downlink control information (DCI), via an activation DCI, or via radio resource control (RRC) signaling.

In a forty-seventh aspect in combination with one or more of the forty-first through forty-sixth aspects, the receiver is further configured to receive a power headroom report (PHR) in accordance with the waveform shaping configuration.

In a forty-eighth aspect in combination with one or more of the forty-first through forty-seventh aspects, the UE is configured to support a first power headroom for uplink transmissions prior to activation of the waveform shaping configuration, and the UE is further configured to support a second power headroom for the uplink transmissions different than the first power headroom after activation of the waveform shaping configuration.

In a forty-ninth aspect in combination with one or more of the forty-first through forty-eighth aspects, the PHR indicates a difference between the first power headroom and the second power headroom.

In a fiftieth aspect in combination with one or more of the forty-first through forty-ninth aspects, the transmitter is further configured to transmit a control message configuring the UE with a first set of resource blocks (RBs) for the signal, and the receiver is further configured to receive the signal using a second set of RBs that includes the first set of RBs and that further includes one or more additional RBs specified by the waveform shaping configuration.

In a fifty-first aspect in combination with one or more of the forty-first through fiftieth aspects, the waveform shaping configuration indicates a plurality of sets of additional RBs, and the transmitter is further configured to transmit an indication of selection of the one or more additional RBs from among the plurality of sets of additional RBs.

In a fifty-second aspect in combination with one or more of the forty-first through fifty-first aspects, the UE is configured to perform, in accordance with the first set of RBs instead of the second set of RBs, an uplink control information (UCI) multiplexing operation that includes multiplexing an uplink control channel transmission with an uplink data channel transmission.

In a fifty-third aspect in combination with one or more of the forty-first through fifty-second aspects, the UE is further configured to perform a power control operation in accordance with the first set of RBs instead of the second set of RBs.

In a fifty-fourth aspect in combination with one or more of the forty-first through fifty-third aspects, the receiver is further configured to receive a demodulation reference signal (DMRS) with the signal in accordance with the first set of RBs instead of the second set of RBs.

In a fifty-fifth aspect in combination with one or more of the forty-first through fifty-fourth aspects, the transmitter is further configured to transmit an indication of a particular demodulation reference signal (DMRS) configuration for use in response to receiving the waveform shaping configuration, and the receiver is further configured to receive a DMRS with the signal, the DMRS having the particular DMRS configuration.

In a fifty-sixth aspect in combination with one or more of the forty-first through fifty-fifth aspects, the transmitter is further configured to transmit an indication of a particular phase tracking reference signal (PTRS) configuration for use in response to receiving the waveform shaping configuration, and the receiver is further configured to receive a PTRS with the signal, the PTRS having the particular PTRS configuration.

In a fifty-seventh aspect in combination with one or more of the forty-first through fifty-sixth aspects, in response to transmitting the configuration message, the receiver is further configured to receive the signal without receive a phase tracking reference signal (PTRS) associated with the signal.

In a fifty-eighth aspect in combination with one or more of the forty-first through fifty-seventh aspects, one or more characteristics of the signal are associated with signal distortion, and the UE is configured with a maximum power reduction (MPR) value to reduce effects of the signal distortion.

In a fifty-ninth aspect in combination with one or more of the forty-first through fifty-eighth aspects, transmission of the signal in accordance with the waveform shaping configuration reduces a peak-to-average power ratio (PAPR) associated with the signal, and the reduced PAPR enables reduction of the MPR value.

In a sixtieth aspect in combination with one or more of the forty-first through fifty-ninth aspects, the waveform shaping configuration is associated with a threshold quantity of resource blocks (RBs), the signal is associated with a particular quantity of RBs, and the UE is further configured to perform, in response to the particular quantity of RBs being less than the threshold quantity of RBs, one or more of selecting another MPR value less than the MPR value or increasing the transmit power level.

In a sixty-first aspect in combination with one or more of the first through sixtieth aspects, a method of wireless communication performed by a network node includes receiving a UE capability message indicating one or more waveform shaping capabilities of a UE. The method further includes transmitting a configuration message indicating a waveform shaping configuration in accordance with the one or more waveform shaping capabilities. The method further includes receiving a signal in accordance with the waveform shaping configuration. The signal has a transmit power level associated with the waveform shaping configuration.

In a sixty-second aspect in combination with the sixty-first aspect, the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

In a sixty-third aspect in combination with one or more of the sixty-first through sixty-second aspects, the UE capability message further indicates, for each of the one or more waveform shaping capabilities, a respective transmit power level capability associated with the waveform shaping capability.

In a sixty-fourth aspect in combination with one or more of the sixty-first through sixty-third aspects, the UE capability message further indicates one or more of a particular quantity of resource blocks (RBs) associated with the waveform shaping or a quantity of bandwidth (BW) associated with the waveform shaping.

In a sixty-fifth aspect in combination with one or more of the sixty-first through sixty-fourth aspects, the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

In a sixty-sixth aspect in combination with one or more of the sixty-first through sixty-fifth aspects, the configuration message is dynamically signaled via downlink control information (DCI), via an activation DCI, or via radio resource control (RRC) signaling.

In a sixty-seventh aspect in combination with one or more of the sixty-first through sixty-sixth aspects, the method includes receiving a power headroom report (PHR) in accordance with the waveform shaping configuration.

In a sixty-eighth aspect in combination with one or more of the sixty-first through sixty-seventh aspects, prior to activation of the waveform shaping configuration, the UE supports a first power headroom for uplink transmissions, and, after activation of the waveform shaping configuration, the UE supports a second power headroom for the uplink transmissions different than the first power headroom.

In a sixty-ninth aspect in combination with one or more of the sixty-first through sixty-eighth aspects, the PHR indicates a difference between the first power headroom and the second power headroom.

In a seventieth aspect in combination with one or more of the sixty-first through sixty-ninth aspects, the method includes transmitting a control message configuring the UE with a first set of resource blocks (RBs) for the signal, and the signal is transmitted using a second set of RBs that includes the first set of RBs and that further includes one or more additional RBs specified by the waveform shaping configuration.

In a seventy-first aspect in combination with one or more of the sixty-first through seventieth aspects, the waveform shaping configuration indicates a plurality of sets of additional RBs, and the method includes transmitting an indication of selection of the one or more additional RBs from among the plurality of sets of additional RBs.

In a seventy-second aspect in combination with one or more of the sixty-first through seventy-first aspects, the UE performs, in accordance with the first set of RBs instead of the second set of RBs, an uplink control information (UCI) multiplexing operation that includes multiplexing an uplink control channel transmission with an uplink data channel transmission.

In a seventy-third aspect in combination with one or more of the sixty-first through seventy-second aspects, the UE is configured to perform a power control operation in accordance with the first set of RBs instead of the second set of RBs.

In a seventy-fourth aspect in combination with one or more of the sixty-first through seventy-third aspects, the method includes receiving a demodulation reference signal (DMRS) with the signal, and the DMRS is received in accordance with the first set of RBs instead of the second set of RBs.

In a seventy-fifth aspect in combination with one or more of the sixty-first through seventy-fourth aspects, the method includes transmitting an indication of a particular demodulation reference signal (DMRS) configuration for use in response to receiving the waveform shaping configuration and receiving a DMRS with the signal, the DMRS having the particular DMRS configuration.

In a seventy-sixth aspect in combination with one or more of the sixty-first through seventy-fifth aspects, the method includes transmitting an indication of a particular phase tracking reference signal (PTRS) configuration for use in response to receiving the waveform shaping configuration and receiving a PTRS with the signal, the PTRS having the particular PTRS configuration.

In a seventy-seventh aspect in combination with one or more of the sixty-first through seventy-sixth aspects, in response to transmitting the configuration message, the UE transmits the signal without transmitting a phase tracking reference signal (PTRS) associated with the signal.

In a seventy-eighth aspect in combination with one or more of the sixty-first through seventy-seventh aspects, one or more characteristics of the signal are associated with signal distortion, and the UE is configured with a maximum power reduction (MPR) value to reduce effects of the signal distortion.

In a seventy-ninth aspect in combination with one or more of the sixty-first through seventy-eighth aspects, transmission of the signal in accordance with the waveform shaping configuration reduces a peak-to-average power ratio (PAPR) associated with the signal, and the reduced PAPR enables reduction of the MPR value.

In an eightieth aspect in combination with one or more of the sixty-first through seventy-ninth aspects, the waveform shaping configuration is associated with a threshold quantity of resource blocks (RBs), the signal is associated with a particular quantity of RBs, and the UE performs, in response to the particular quantity of RBs being less than the threshold quantity of RBs, one or more of selecting another MPR value less than the MPR value or increasing the transmit power level.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software may include instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, one or more features described herein may be implemented via processor circuitry, via executable instructions, or combinations thereof.

Those of skill would further appreciate that the various illustrative logical blocks, modules, circuits, and operations described herein may be implemented as electronic hardware, computer software, or combinations of both. To illustrate, various illustrative components, blocks, modules, circuits, and operations may be described above generally in terms of their functionality. Whether such functionality is implemented as hardware or software may depend upon the particular application and design of the overall system.

A hardware and data processing apparatus used to implement one or more various illustrative logics, logical blocks, modules, and circuits described herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, one or more functions described herein may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or process disclosed herein may be implemented in a processor-executable software module which may reside on a computer-readable medium. Computer-readable media includes computer storage media. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a transmitter configured to transmit a UE capability message indicating one or more waveform shaping capabilities of the UE; and
a receiver configured to receive a configuration message indicating a waveform shaping configuration in accordance with the one or more waveform shaping capabilities,
wherein the transmitter is further configured to transmit a signal in accordance with the waveform shaping configuration, the signal having a transmit power level associated with the waveform shaping configuration.

2. The apparatus of claim 1, wherein the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

3. The apparatus of claim 1, wherein the UE capability message further indicates, for each of the one or more waveform shaping capabilities, a respective transmit power level capability associated with the waveform shaping capability.

4. The apparatus of claim 1, wherein the UE capability message further indicates one or more of a particular quantity of resource blocks (RBs) associated with the waveform shaping or a quantity of bandwidth (BW) associated with the waveform shaping.

5. The apparatus of claim 1, wherein the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

6. The apparatus of claim 1, wherein the receiver is further configured to receive the configuration message dynamically via downlink control information (DCI), via an activation DCI, or via radio resource control (RRC) signaling.

7. The apparatus of claim 1, wherein the transmitter is further configured to transmit a power headroom report (PHR) in accordance with the waveform shaping configuration.

8. The apparatus of claim 7, wherein the UE is configured to support a first power headroom for uplink transmissions prior to activation of the waveform shaping configuration, and wherein the UE is further configured to support a second power headroom for the uplink transmissions different than the first power headroom after activation of the waveform shaping configuration.

9. The apparatus of claim 8, wherein the PHR indicates a difference between the first power headroom and the second power headroom.

10. The apparatus of claim 1, wherein the receiver is further configured to receive a control message configuring the UE with a first set of resource blocks (RBs) for the signal, and wherein the transmitter is further configured to transmit the signal using a second set of RBs that includes the first set of RBs and that further includes one or more additional RB s specified by the waveform shaping configuration.

11. The apparatus of claim 10, wherein the waveform shaping configuration indicates a plurality of sets of additional RBs, and wherein the receiver is further configured to receive an indication of selection of the one or more additional RB s from among the plurality of sets of additional RBs.

12. The apparatus of claim 10, wherein the transmitter is further configured to perform, in accordance with the first set of RBs instead of the second set of RBs, an uplink control information (UCI) multiplexing operation that includes multiplexing an uplink control channel transmission with an uplink data channel transmission.

13. The apparatus of claim 10, wherein the UE is further configured to perform a power control operation in accordance with the first set of RB s instead of the second set of RBs.

14. The apparatus of claim 10, wherein the transmitter is further configured to transmit a demodulation reference signal (DMRS) with the signal in accordance with the first set of RBs instead of the second set of RBs.

15. The apparatus of claim 1, wherein the receiver is further configured to receive an indication of a particular demodulation reference signal (DMRS) configuration for use in response to receiving the waveform shaping configuration, and wherein the transmitter is further configured to transmit a DMRS with the signal, the DMRS having the particular DMRS configuration.

16. The apparatus of claim 1, wherein the receiver is further configured to receive an indication of a particular phase tracking reference signal (PTRS) configuration for use in response to receiving the waveform shaping configuration, and wherein the transmitter is further configured to transmit a PTRS with the signal, the PTRS having the particular PTRS configuration.

17. The apparatus of claim 1, wherein, in response to receiving the waveform shaping configuration, the transmitter is further configured to transmit the signal without transmitting a phase tracking reference signal (PTRS) associated with the signal.

18. The apparatus of claim 1, wherein one or more characteristics of the signal are associated with signal distortion, and wherein the UE is configured with a maximum power reduction (MPR) value to reduce effects of the signal distortion.

19. The apparatus of claim 18, wherein transmission of the signal in accordance with the waveform shaping configuration reduces a peak-to-average power ratio (PAPR) associated with the signal, and wherein the reduced PAPR enables reduction of the MPR value.

20. The apparatus of claim 18, wherein the waveform shaping configuration is associated with a threshold quantity of resource blocks (RBs), wherein the signal is associated with a particular quantity of RBs, and wherein the UE is further configured to perform, in response to the particular quantity of RBs being less than the threshold quantity of RBs, one or more of selecting another MPR value less than the MPR value or increasing the transmit power level.

21. A method of wireless communication performed by a user equipment (UE), the method comprising:
transmitting a UE capability message indicating one or more waveform shaping capabilities of the UE;
receiving a configuration message indicating a waveform shaping configuration in accordance with the one or more waveform shaping capabilities; and
transmitting a signal in accordance with the waveform shaping configuration, the signal having a transmit power level associated with the waveform shaping configuration.

22. The method of claim 21, wherein the one or more waveform shaping capabilities include one or more of frequency domain spectrum shaping (FDSS) with bandwidth (BW) expansion, FDSS without BW expansion, tone reservation (TR), one or more supported spectrum flatness parameters, or one or more supported radio frequency (RF) relaxation parameters.

23. The method of claim 21, wherein the UE capability message further indicates, for each of the one or more waveform shaping capabilities, a respective transmit power level capability associated with the waveform shaping capability.

24. The method of claim 21, wherein the UE capability message further indicates one or more of a particular quantity of resource blocks (RBs) associated with the waveform shaping or a quantity of bandwidth (BW) associated with the waveform shaping.

25. An apparatus for wireless communication by a network node, the apparatus comprising:
a receiver configured to receive a user equipment (UE) capability message indicating one or more waveform shaping capabilities of a UE; and
a transmitter configured to transmit a configuration message indicating a waveform shaping configuration in accordance with the one or more waveform shaping capabilities,
wherein the receiver is further configured to receive a signal in accordance with the waveform shaping configuration, the signal having a transmit power level associated with the waveform shaping configuration.

26. The apparatus of claim 25, wherein the waveform shaping configuration indicates configuration of the UE with one or more of frequency domain spectrum shaping (FDSS) with bandwidth (BW) expansion, FDSS without BW expansion, tone reservation (TR), an excess BW for the waveform shaping, one or more configured spectrum flatness parameters, or one or more configured radio frequency (RF) relaxation parameters.

27. The apparatus of claim 25, wherein the transmitter is further configured to transmit the configuration message dynamically via downlink control information (DCI), via an activation DCI, or via radio resource control (RRC) signaling.

28. A method of wireless communication performed by a network node, the method comprising:
receiving a user equipment (UE) capability message indicating one or more waveform shaping capabilities of a UE;
transmitting a configuration message indicating a waveform shaping configuration in accordance with the one or more waveform shaping capabilities; and
receiving a signal in accordance with the waveform shaping configuration, the signal having a transmit power level associated with the waveform shaping configuration.

29. The method of claim 28, further comprising receiving a power headroom report (PHR) in accordance with the waveform shaping configuration.

30. The method of claim 29, wherein, prior to activation of the waveform shaping configuration, the UE supports a first power headroom for uplink transmissions, and wherein, after activation of the waveform shaping configuration, the UE supports a second power headroom for the uplink transmissions different than the first power headroom.
